(19) United States
(12) Patent Application Publication
(10) Pub. No.: US 2008/0263214 A1
(43) Pub. Date: Oct. 23, 2008

(54) Systems and Methods for Rapid Integration of Data Storage Subsystems

(76) Inventors: Mark P. Austin, Plano, TX (US); Mathew M. Kaippallimalil, Plano, TX (US); Manish Kolhe, Plano, TX (US); Sharon Lim, Plano, TX (US); Daniel E. Lohmar, Plano, TX (US); David C. Williamson, Plano, TX (US); Dan Yarbrough, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/737,643

(22) Filed: Apr. 19, 2007

(51) Int. Cl. G06F 15/16

(52) U.S. Cl. 709/229

(57) ABSTRACT

A computer system includes a computer processor and logic instructions for rapid integration of data storage subsystems. An adapter factory is instantiated in response to a request from a client computer. The adapter factory is configured to provide a generic persistent data storage (Pds) adapter interface to the client computer. The Pds adapter interface interfaces to a specific adapter. The Pds adapter interface is configured to invoke corresponding data source operations in the specific adapter. A generic Pds data source interface is configured between the specific adapter and a specific data source.

### BACKGROUND OF THE INVENTION

A database can be configured to store data records as well as one or more types of files. A relational database typically includes one or more tables with one or more columns and rows of data. The information in the data tables can be related to information in other tables through one-to-one, one-to-many, and many-to-many relationships. Databases are often interfaced to database servers to allow access by multiple users via a network.

Database content is typically accessed via an application program on a client computer. In the past, if a database architecture was added or modified, the application and server programs would have to be modified to work with the new or modified database. In highly distributed systems with multiple client computers, several weeks were often required to implement the change due to the existence of many different applications for the same database, as well as to distribute the changes throughout an organization.

### SUMMARY

In accordance with an embodiment of the present invention, a computer system includes a computer processor and logic instructions for rapid integration of data storage subsystems. An adapter factory is instantiated in response to a request from a client computer. The adapter factory is configured to provide a generic persistent data storage (Pds) adapter interface to the client computer. The Pds adapter interface interfaces to a specific adapter. The Pds adapter interface is configured to invoke corresponding data source operations in the specific adapter. A generic Pds data source interface is configured between the specific adapter and a specific data source.

### BRIEF DESCRIPTION OF THE DRAWINGS

Embodiments of the invention relating to both structure and method of operation may best be understood by referring to the following description and accompanying drawings:

FIG. 1 is a schematic block diagrams depicting an embodiment of an apparatus for integrating data sources;

FIG. 2 is schematic block diagram of an embodiment of components included in a server for integrating data sources;

FIG. 3 is a flow chart of an embodiment of a method for integrating data sources;

FIG. 4 shows an embodiment of a model of the PdsAdapterFactory class;

FIG. 5 shows an embodiment of a model of the PdsAdapter class;

FIG. 6 shows an embodiment of a model of PdsContextManager;

FIG. 7 shows an embodiment of a model of a JdbcAdapter class;

FIG. 8 shows an embodiment of a model of a PdsDataSource interface; and

FIG. 9 shows an embodiment of a model of a JdbcDataSource class.

### DETAILED DESCRIPTION

In order to allow rapid integration of new or modified databases, generic persistent data storage (PDS) adapter and data source interfaces are provided that interface with one or more adapters that are specific to a corresponding data source. The PDS adapter does not require the client application to have any knowledge of the underlying structure of the data source. Accordingly, the data source may be modified and new data sources may be added without requiring a change to the client application. Such features alleviate the time-consuming and expensive process of modifying client applications to interface with new data source architectures, and distributing the changes to all users of the changed/updated data source.

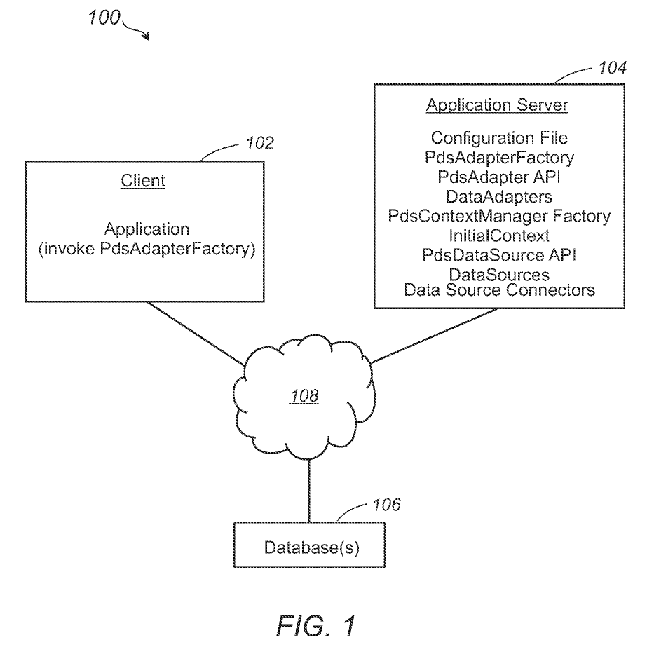

Referring to FIG. 1, a block diagram of an embodiment of a system 100 for integrating data sources is shown including client computer 102, application server 104, and database(s) 106. The components of system 100 can be configured to communicate with one another via a communication network 108 such as a local area network, a wide area network, or a global information network, such as the Internet.

Client computer 102 is configured with one or more application programs that add, delete, modify, and/or query information in the database 106. Other suitable operations can be implemented, such as listing database elements by primary keys or foreign keys, and counting database elements by a key, where a primary key uniquely identifies a row in a table and a foreign key identifies a column or a set of columns in one table that refers to a column or set of columns in another table.

Server 104 can be configured with different levels of application programming interfaces (APIs) and factories (also referred to managers). In the embodiment shown, server 104 includes a (Persistent Data Storage) PdsAdapterFactory, PdsAdapterAPI, DataAdapters, PdsContextManager, InitialContext, PdsDataSource API, and one or more DataSources. In some embodiments server 104 is an application server, for example, a J2EE application server, commercially available from a number of vendors such as the WebLogic Server by BEA, Inc., JBoss from Red Hat, Inc., WebSphere from IBM Corporation, JRun by Adobe Corporation, and Oracle OC4J by Oracle Corporation. Software components in client computer 102 and server 104 can be configured to run in a Java Virtual Machine (JVM) or other suitable platform. A JVM is a virtual machine that interprets and executes Java bytecode that is generated by Java language compilers or compilers of other languages that target the JVM and adhere to the JVM standard published by Sun Microsystems, Inc.

System 100 can be configured to accommodate persistent data storage, which makes the state of an application available between instances of a process. The application program in client computer 102 can be configured to invoke persistent data storage (Pds) AdapterFactory to instantiate a PdsAdapter Factory on server 104. The PdsAdapterFactory creates a PdsAdapter API and a specific data adapter, and returns the PdsAdapter API class to the application program on the client computer 102. The PdsAdapter API provides a generic interface to any of the specific data adapters, such as a Java Database Connectivity (JDBC) adapter or other suitable adapter. The PdsDataSource API provides a generic interface to any specific data sources, such as a JDBC DataSource. By using the generic PdsAdapter and PdsDataSource APIs, changes to the underlying architecture of the database are transparent to the user and to the majority of other components in system 100. For example, the database being used by a client application may be switched from one type to another by pointing to another datasource in a configuration file at runtime. No changes are required to the client application, the PdsAdapterFactory, the PdsAdapter API, the PdsContextManager, or the PdsDataSource API. System 100 thus provides the ability to rapidly transition to new database architectures.

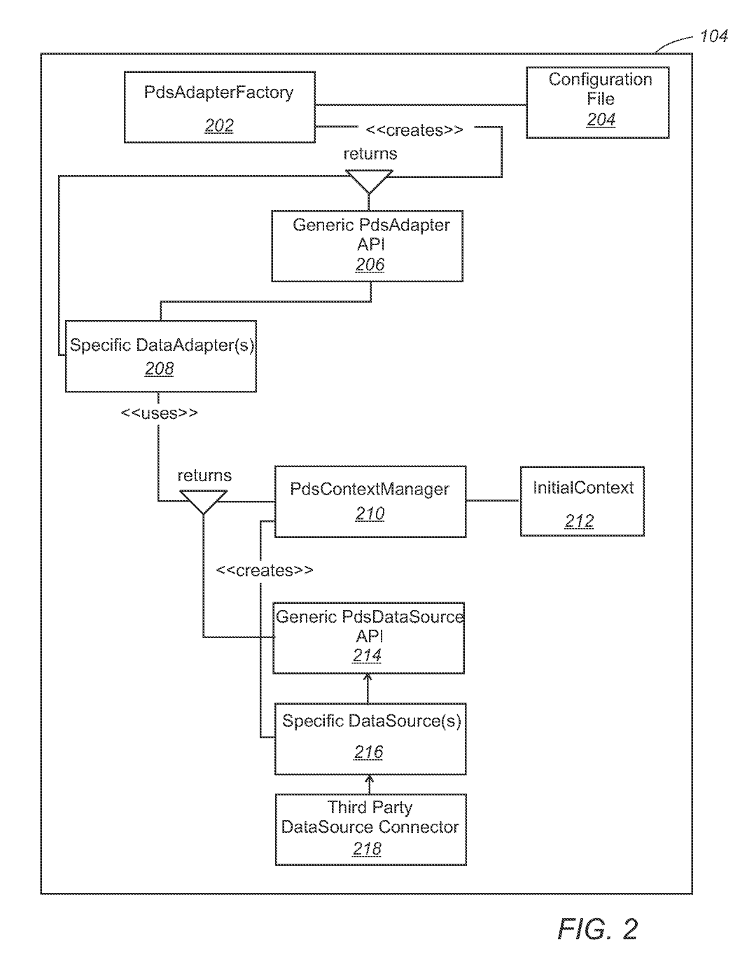

FIG. 2 shows an embodiment of relationships among components included in the server 104 (FIG. 1). PdsAdapterFactory 202 can use a configuration file 204 to determine the specific type of DataSource 216 to be used by the client application. Once the datasource configuration is determined, the PdsAdapterFactory 202 creates a PdsAdapter API 206 and a Specific DataAdapter 208. The PdsAdapter API class 206 is returned to the application program in client computer 102 (FIG. 1). Note that PdsAdapterFactory 202 can create any type of SpecificDataAdapter 208, depending on the type of DataSource 216 specified in the configuration file 204.

A generic PdsDataSource API class 214 is returned to the SpecificDataAdapter 208. The SpecificDataAdapter 208 also uses a PdsContextManager 210 to locate a generic data source interface (shown as PdsDataSource API 214). The PdsDataSource API 214 provides a generic interface to a Specific DataSource 216. PdsContextManager 210 can use any suitable facility for locating components, such as Java Naming and Directory Interface (JNDI), denoted by InitialContext 212. The PdsContextManager 210 can also create a SpecificDataSource 216 according to a standard format, such as the JDBC standard. The SpecificDataSource 216 interfaces with a third party DataSource connector 218, which interfaces with a database to process command statements and return results to the client application via the Specific DataSource 216.

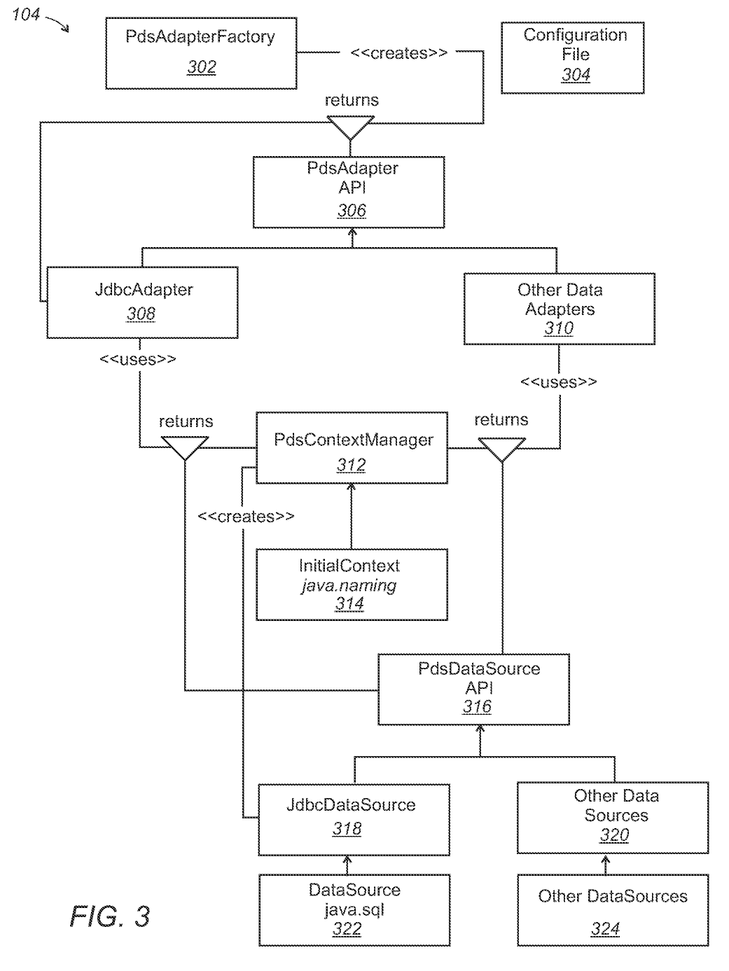

FIG. 3 shows a block diagram of another embodiment of server 104 (FIG. 1) in which some of the components are implemented according the JDBC API standard. One of the adapters 308 is a Java Database Connectivity (Jdbc)Adapter 308, although other data adapters 310 may be implemented in addition to or instead of the JdbcAdapter 308. The Java Database Connectivity (JDBC) API provides database-independent connectivity between the Java programming language and a wide range of databases including SQL databases and other tabular data sources, such as spreadsheets or flat files. The JDBC API further provides a call-level API for SQL-based database access. JDBC API allows Java applets, servlets, and standalone applications to access persistent data stored in relational database management systems. Persistent relational databases allow data to be accessed through a logical model, thereby avoiding the limitations of supplying information about physical storage locations. The database is a source of application data and provides persistence services to Java objects. JDBC is independent of the various database management systems, which use their own proprietary protocols. Thus, the database vendors supply a connector (also referred to as a datasource) between the JDBC datasource and the database.

The PdsAdapterFactory 302 is instantiated in response to a request from a client computer, and configured to provide a generic persistent data storage PdsAdapter interface 306 to the client computer. A configuration file 304 is accessed by the PdsAdapterFactory 302 to determine the type of database that will be accessed by the application program on the client computer.

The PdsAdapter interface 306 interfaces to one or more specific adapters, such as the JdbcAdapter 308 as well as other suitable data adapters 310. The PdsAdapter interface 306 is configured to invoke corresponding data source operations in the specific adapters 308, 310.

Server 104 further includes one or more specific data sources, shown as JdbcDataSource 318 and other DataSources 320. A generic PdsData Source interface 316 is configured between the specific adapters 308, 310 and the specific data sources 318, 320. The specific data sources 318, 320 translate commands from the generic PdsData Source interface 316 to perform functions specific to data sources 318, 320. For example, the JdbcDataSource 318 uses the standard class java.sql.DataSource to perform specific JDBC functions.

Context manager 312 is configured to locate the specific data sources 318, 320 using a name and directory interface service, such as the JNDI that is included in a Java Virtual Machine (JVM). The location and name of the specific data sources 318, 320 can be registered in the JNDI to allow remote instantiation of the specific adapter from the PdsAdapter interface 306. Thus, even though there may be several specific adapters 308, 310 available, the configuration file 304 enables the PdsAdapterFactory 302 to provide the correct specific adapter from among a plurality of specific adapters 308, 310. Likewise, the PdsContextManager 312 provides a name for the specific DataSource 318, 320 that corresponds to the data adapter 308, 310 to be used from among the plurality of specific data sources.

Various types of databases, data, and files can be accessed by the specific DataSources 319, 320, such as XML files, data tables, common flat files, and NonStop Kernel (NSK) files. In-memory storage can also be accessed without the use PdsContextManager 312 or datasources 318, 320, 322, 324. System 100 is flexible enough to allow a client application to utilize in-memory storage as well as datasources 322, 324 provided by third parties. Note that only the PdsAdapter API 306 and a specific data adapter 308, 310 are required when in-memory storage is used since there is no need to access a database through datasources 318, 320, 322, 324.

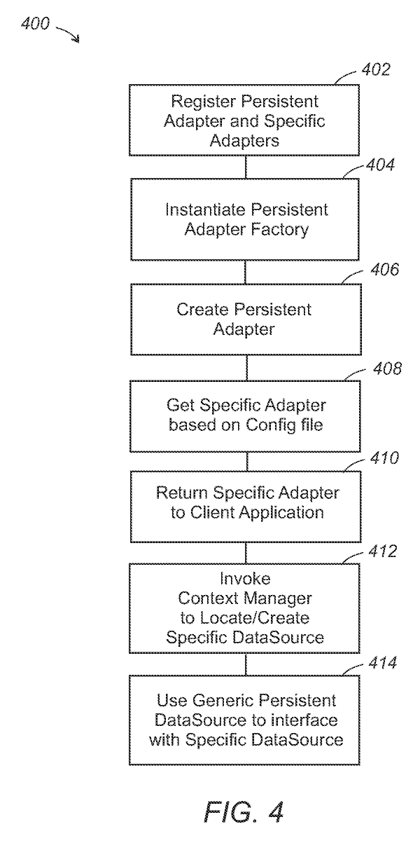

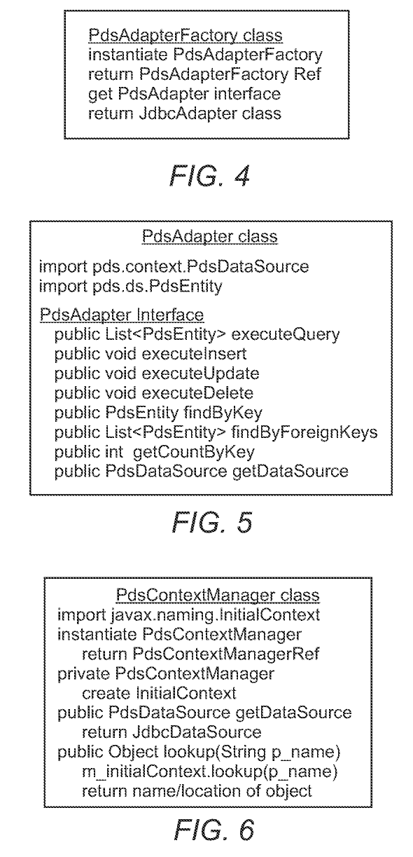

Referring to FIG. 4, a flow diagram of an embodiment of a method 400 for integrating data storage subsystems is shown. Process 402 includes registering a generic persistent adapter and a plurality of specific adapters with a name and directory service, such as the JNDI or other suitable facility. Registration in the directory or other accessible facility allows other components in system to determine the name and location of the desired adapters.

Process 404 includes instantiating a persistent adapter factory in response to a request from a client computer. In process 406, the adapter factory creates a generic persistent adapter. The adapter factory gets the name and location of a specific adapter to be used based on a configuration file in process 408. The name and location of the specific adapter is supplied to the client application in process 410.

The generic persistent adapter receives commands/requests from the client application and translates the commands/requests to a format required by the specific adapter. The specific adapters are configured to interface with a corresponding specific data source. Process 412 invokes a context manager to determine the name and location of a generic persistent datasource. The persistent datasource is independent of the type of database being used. Accordingly, changes can be made to the underlying database without affecting other components of the application server or the client application.

Process 414 includes using the generic persistent datasource to interface with a specific datasource. The generic persistent datasource provides a level of abstraction for the specific datasource. The client application thus does not need to be customized to interface with a specific adapter and datasource, but rather is able to use generic interfaces to any specific type of adapter and datasource.

Referring now to FIGS. 4 through 9, examples of the classes and functions included in various components in application server 104 (FIG. 3) are shown for a system that uses the JDBC standard. Note that other specific adapter classes that do not use Java will be implemented according to the standards of the particular data base management system being used. FIG. 4 shows an embodiment of a model of the PdsAdapterFactory class that intantiates a PdsAdapterFactory, and returns a PdsAdapterFactory reference to the client application. The PdsAdapterFactory also creates the generic PdsAdapter interface and returns the generic class, to the client application.

FIG. 5 shows an embodiment of a model of the PdsAdapter class that is configured to use generic commands to interface with a plurality of different specific adapters. In the example shown, the pds.context.PdsDataSource class and pds.ds.PdsEntity classes are imported. The PdsAdapter interface is also included to provide a generic interface to functions that are commonly performed in various database management systems including executing queries, inserts, updates, deletes, finding data using a key or a foreign key, and getting data counts by keys. The PdsAdapter interface also includes a method to get the DataSource via the PdsDataSource interface.

FIG. 6 shows an embodiment of a model of PdsContextManager class that imports javax.naming.lnitialContext class, which is part of the Java standard. PdsContextManager class also instantiates a PdsContextManagerRef and returns the reference to the client application. The PdsContextManager class further includes a method to get a specific datasource (shown as Jdbc Datasource), and a lookup method to lookup the JNDI name and location of an object that is specified when the lookup method is invoked.

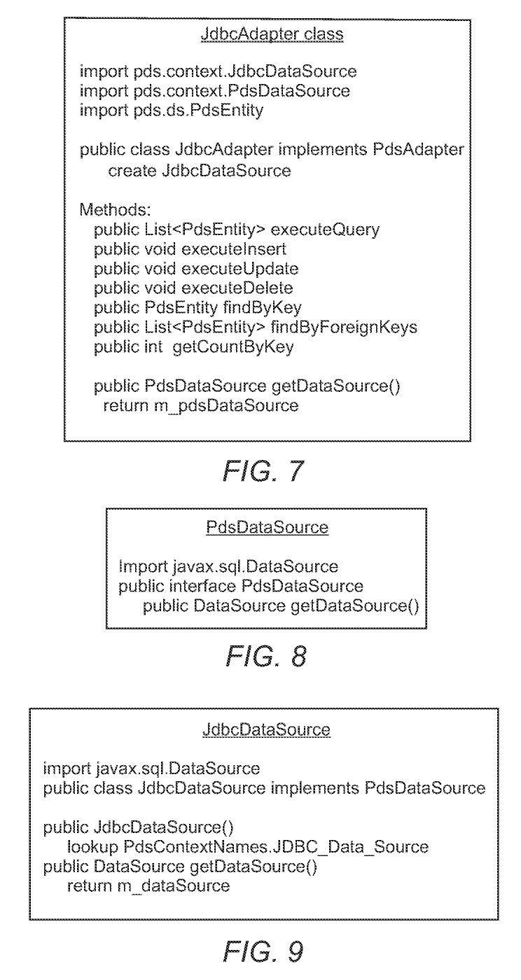

Referring to FIG. 7, an embodiment of a model of a JdbcAdapter class is shown that imports the pds.context.JdbcDataSource, pds.context.PdsDataSource, and the pds.ds.PdsEntity classes. The JdbcAdapter class is declared to implement the PdsAdapter interface class, and the JdbcDataSource is created. The JdbcAdapter interface implements methods according to the JDBC standard for functions that are commonly performed in various database management systems including executing queries, inserts, updates, deletes, finding data using a key or a foreign key, and getting data counts by keys. The JdbcAdapter interface also includes a method to get the DataSource via the PdsDataSource interface and return to the DataSource to the client application.

FIG. 8 shows an embodiment of a model of a PdsDataSource interface that imports javax.sql.DataSource, which is a standard class available in the Java programming language. The PdsDataSource interface is further configured to invoke the DataSource method to get the JdbcDataSource to be used.

FIG. 9 shows an embodiment of a model of a JdbcDataSource class that imports the javax.sql.DataSource class. The JdbcDataSource class is declared to implement the PdsDataSource interface class. The JdbcDataSource class further invokes a lookup method to lookup the name and location of the Jdbc_Data_Source. The name/location of the JdbcDataSource is returned to the client application.

The various functions, processes, methods, and operations performed or executed by system 100 can be implemented as programs that are executable on various types of computer processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, a few specific examples of dialogs and data models are described. The illustrative system for declarative association of dialog fields can be used with any suitable dialogs or data models. The illustrative techniques may be used with any suitable data processing configuration and with any suitable servers, computers, and devices. In the claims, unless otherwise indicated the article “a” is to refer to “one or more than one”.

What is claimed is:

1. A computer system comprising:
a computer processor; and
logic instructions on computer readable media and executable by the computer processor, the logic instructions including:
an adapter factory instantiated in response to a request from a client computer, and configured to provide a generic persistent data storage (Pds) adapter interface to the client computer;
the Pds adapter interface interfaces to a specific adapter, the Pds adapter interface is configured to invoke corresponding data source operations in the specific adapter;
a specific data source; and
a generic Pds data source interface configured between the specific adapter and the specific data source.

2. The system according to claim 1, the logic instructions further comprising:
a configuration file that specifies a type of database that will be accessed by the application program on the client computer.

3. The system according to claim 2 further comprising:
a context manager configured to locate the specific data source, the context manager utilizes a name and directory interface service.

4. The system according to claim 2 further comprising:
the context manager utilizes a register class in a Java Virtual Machine (JVM) that allows remote instantiation of the specific adapter from the Pds adapter interface.

5. The system according to claim 1 further comprising:
a plurality of specific adapters; and
the adapter factory configured to provide the specific adapter from among the plurality of specific adapters.

6. The system according to claim 5 further comprising:
the specific data source includes at least one of the group consisting of:
XML files, data tables, common flat files, NonStop Kernel (NSK) files, and in-memory cluster storage.

7. The system according to claim 5 further comprising:
a plurality of specific data sources corresponding to the plurality of specific adapters; and
a context manager configured to provide a name for the specific data source driver from among the plurality of specific data sources.

8. An automated method for integrating data sources comprising:
instantiating a persistent data storage (Pds) adapter factory in response to a request from a client computer;
creating a Pds adapter;
providing a specific adapter from among a plurality of specific adapters based on a configuration file, wherein the specific adapters are configured to access a corresponding specific data source.

9. The method according to claim 8 further comprising:
invoking a context manager to locate the specific adapter.

10. The method according to claim 9 further comprising:
registering the Pds adapter and the plurality of specific adapters with a name and directory service.

11. The method according to claim 8 further comprising:
the configuration file specifies a database to be accessed.

12. The method according to claim 7 further comprising:
the data sources include at least one of the group consisting of: XML files, data tables, common flat files, NonStop Kernel (NSK) files, and in-memory cluster storage.

13. A computer program product comprising:
logic instructions on computer readable media including:
a Pds adapter factory instantiatable on a server, the Pds adapter factory operable to provide a generic persistent data storage (Pds) adapter to a client application program;
the Pds adapter is configured to interface with a plurality of specific adapters; and
a Pds data source interface configured to interface with the plurality of specific adapters and a corresponding plurality of specific data sources.

14. The computer program product according to claim 13, the logic instructions further comprising:
a context manager configured to locate the specific data sources.

15. The computer program product according to claim 14 further comprising:
the context manager utilizes a Java name and directory interface (JNDI) to locate the specific data sources.

16. The computer program product according to claim 13 further comprising:
a plurality of specific adapters; and
the adapter factory configured to create the specific adapter from among the plurality of specific adapters.

17. The computer program product according to claim 16 further comprising:
the specific data source includes at least one of the group consisting of:
XML files, data tables, common flat files, NonStop Kernel (NSK) files, and in-memory cluster storage.

18. The computer program product according to claim 17 further comprising:
a plurality of specific data sources corresponding to the plurality of specific adapters; and
a context manager configured to provide a name for the specific data source driver from among the plurality of specific data sources.

19. The computer program product according to claim 13 further comprising:
a client application program configured to invoke the Pds adapter factory and to receive the persistent data storage (Pds) adapter interface to one of the plurality of specific adapters; and
the Pds adapter interface is configured to invoke corresponding data source operations in the one of the specific adapters.

20. The computer program product according to claim 13 further comprising:
a configuration file that specifies a database to be accessed.
